(19) United States
(12) Patent Application Publication
(10) Pub. No.: US 2017/0071825 A1
(43) Pub. Date: Mar. 16, 2017

(54) MERIDIAN BENDING NEEDLING METHOD AND FILIFORM MERGE CLUSTER NEEDLE DEVICE

(71) Applicants: Canglin Li, Shandong (CN); Zuoqiang Li, Shandong (CN); Li Ma, Shandong (CN); Liting Zhang, Shandong (CN); Yanbin Gao, Shandong (CN)

(72) Inventors: Canglin Li, Shandong (CN); Zuoqiang Li, Shandong (CN); Li Ma, Shandong (CN); Liting Zhang, Shandong (CN); Yanbin Gao, Shandong (CN)

(21) Appl. No.: 15/243,109

(22) Filed: Aug. 22, 2016

(30) Foreign Application Priority Data
Sep. 12, 2015 (CN) 201510576929.3

(51) Int. Cl. A61H 39/08

(52) U.S. Cl. CPC A61H 39/086

(57) ABSTRACT

Meridian bending needling method requires practitioners to obliquely insert an acupuncture needle by 10-30 degrees, and subsequently move the needle along subcutaneous muscle layer until the needle completely merges into patients' skin. This type of acupuncture method allows practitioners to stimulate multiple acupoints and meridian channel at the same time. The invented filiform merge cluster needle device applied in meridian-bending needling method comprises two or more single needles fixed in parallel; said single needle comprises five parts including a needle tip, needle body, needle root, needle handle, and needle end connected respectively. Single needles are fixed together by binding, tape, welding or snapping. Compared to existing technologies, the therapeutic effects of meridian-bending needling method are remarkable, and the method is much safer. The filiform merge cluster needle is stronger, safer, and more convenient to manipulate, and can be applied to bending needling and retaining needling manipulations.

This application claims priority to Chinese Application No. 201510576929.3, filed on Sep. 12, 2015, to the extent allowed by law and the contents of which are incorporated herein by reference in their entireties.

### TECHNICAL FIELD

This invention belongs to Traditional Chinese medicine acupuncture therapy and needling device technical field, and specifically, the present invention is a meridian bending needling method and a kind of filiform merge cluster needle device.

### BACKGROUND

Based on Traditional Chinese acupuncturists' numerous clinical practices and observations, meridian theory is finally established. Three traditional Chinese treatments, namely, moxibustion therapy, stone needling therapy, and guiding therapy, utilize the meridian theory. Moreover, stone needling therapy is the predecessor of acupuncture therapy, a simple treatment can be traced back to ancient times, which utilizes Acuturris-made stone needle to stimulate certain parts of the body to relieve pain.

Research concerning acupuncture therapeutic methods have revealed its therapeutic effects as follows:

First, it can regulate channels, dredging meridian obstruction to restore the normal physiological effects. Traditional Chinese Medicine believes that the meridian connects viscera with body surface and, thus, promoting visceral organs into an integral entirety. One of the important physiological effects of meridian is to allow Qi (vital energy) and blood to circulate. Clinical manifestations of meridian obstruction include pain, numbness, swelling and ecchymosis.

Second, acupuncture can harmonize Yin and Yang and cure diseases by restoring the equilibrium between the two. Traditional Chinese Medicine believes that all diseases are generated from Yin and Yang imbalance. Acupuncture therapeutic method harmonizes the two through using the meridian's characteristics together with acupoints' compatibility and acupuncture manipulation.

Third, acupuncture can strengthen body resistance to eliminate pathogenic factors. Traditional Chinese Medicine believes that the process of disease occurrence and disease outcome results from the process of the contention between Qi and pathogenic factors. Here lies the reason why acupuncture can cure diseases. The following points address how acupuncture can cure diseases.

With the continuous development of productivity, the acupuncture needle goes through various evolutionary processes, including stone needles, bone needles, bronze needles, iron needles, golden needles, silver needles, and, nowadays, austenitic stainless needles. Contemporary acupuncturists also apply technologies, such as, radio wave, electromagnetism, laser, ion, and microwave into filiform needle acupuncture therapy, which endow traditional acupuncture therapy with modern colors. However, up until now, acupuncture therapy could only cure diseases by respectively stimulating every meridian acupoint to incur meridian responses, rather than directly acting upon the whole meridian to stimulate overall responses.

In recent years, traditional acupuncture has made few improvements on clinical practices with obvious defects as follows. It placed too much emphasis on repeated vertical pricking needling, which requires numerous treatments per acupoint. Some developed single needling between two acupoints (such as Dicang and Jiache) with a certain angle. Needling retaining time is usually short within 20-30 minutes each time per day.

In sum, traditional acupuncture therapy requires patients to accept treatments every day or every other day for a rather long period of time. Moreover, long-term treatment courses are not only economically burdensome for the patients but also time consuming for the acupuncturists. Multiple pricking on a single acupoint will provide very limited effects on meridian conductive stimulation. Therefore, it fails to totally stimulate the meridian's overall regulations on body and as a result, fails to timely control diseases. The treatment effect is very limited.

At present, commonly used needles include filiform needles, auricular needles, acusector needles, three-edged needles and dermal needles. The most common is the filiform needle, which is composed of a tip, body, root, handle, and end. A needle tip refers to the sharp part of a needle, also known as the “pinpoint”; a needle body refers to the main part between a needle tip and a needle handle, which forms different specifications of needles concerning the length and thickness of filiform needles. The needle root connects a needle body and a needle handle. A needle handle refers to the holding part that is held by an acupuncturer following a needle body and a needle root. A needle handle and a needle end are often twined with copper wire or silver wire, presenting a helical or cylindrical form. In addition, various forms of needle handles include coil handles, floral handles, flat handles and pipe handles. Commonly used acupuncture needle specification requires the needle thickness to be size 28˜30 (0.32˜0.38 mm) and needle length to be 1˜3 cun (25˜75 mm). Due to its soft material and thin body nature, when operating a traditional filiform needle, acupuncturists were required to adopt bending needling and retaining needling therapy at a relatively small angle. Such therapeutic operation encounters large resistance from human body, and it is hard for acupuncturists to control directions and may bend the needle.

### SUMMARY

The present invention aims to solve aforementioned defects and provides a filiform merge cluster needle device and meridian bending needling therapy method, which allows manipulation on multiple acupoints at the same time and a longer needle retaining time.

The invented method for treating patients with meridian bending needling therapy comprises steps of preparation for needling, manipulation of needle devices, needle retaining and observation, and needle withdrawal. Manipulation of needling devices comprises the steps of pinching the needling device with both hands. To be specific, the acupuncturist shall wrap a latter part of a needle with sterilized dry cotton balls with the thumb and forefinger of his or her right hand. If the needling device is equipped with a thin sliding sleeve, snap joints or fixation clips, they have to be fixed at a point 2-3 cm from a needle tip, which allows the needle tip exposed for 1-2 cm. In addition, the needle tip is required to be placed on a patient's skin surface. If using a needling device connected by welding or tape, the acupuncturist has to insert the device into skin surface for 1 cm in an angle ranging from 10 to 30 degree with full hand strength. Insertion direction and angle are determined by the patient's body shape and weight. When the insertion direction derivates excessively from the meridian orientation or the insertion angle is either too large or too small, the needle tip can be slightly withdrawn and adjusted subcutaneously. The needle handle shall be inserted with force in the direction parallel with skin surface with the acupuncturist's left hand. The acupuncturist shall maintain the stability of his right hand in order to prevent curve or breaking incurred by a patient's skin and/or muscular tissue resistance, or excessive hand force. The needling insertion is not complete until the full immergence of the needle body into a patient's skin surface. During needle retaining period, the acupuncturist shall fix the needle handles with sterilized medical tape in case of needle sliding and, meanwhile, advise the patient not to move. During needle withdrawal, for welding-connected needling device, the tape fixed on needle handle shall be removed first. Subsequently, the acupuncturist may slightly press on manipulation acupoints with a sterilized dry cotton ball with thumb and forefinger of the left hand and, meanwhile, retain needling for some time before slowly withdrawing the device with the right hand. For needling devices connected by tape, the acupuncturist may respectively draw out single filiform needle after removing the tape binding.

The needle device used in meridian bending needling therapy comprised of two or more single needles fixed together through binding, tape, welding or snap joint. Each single needle includes a needle tip, needle body, needle root, needle handle, and needle end connected respectively.

Compared with existing technologies, the meridian bending needling therapy has the following characteristics. Firstly, it modifies traditional point-by-point acupuncture method and adopts longitudinal and linear acupuncture, which travels along Meridians using horizontal needling method with needle maintaining. In this way, each needle can cover multiple adjoining acupoints, and an acupuncturist can move the needle along the superficial muscular layer easily and safely. Secondly, the gentle meridian manipulation with needling retaining increases curative effects compared to the traditional point-to-point acupuncture and achieves the effect that the traditional point-to-point acupuncture method cannot. Thirdly, the invented therapy directly stimulates the whole meridian along meridian channel, thereby connecting acupoints in series from point to line. At the same time, benign compression stimulation of filiform needle body along with multiple meridian channels constructs a relationship among meridians, which may stimulate the whole meridian network and even incur potential meridian power to a large extent. Fourthly, the invented needle instrument is manipulated along the meridian channel direction. Specifically, the acupuncturist shall adopt horizontal needling and maintain the needle within meridian channels. Moreover, several needles can be connected in series or parallel along with meridian direction in one region such as Urinary Bladder Meridian and other meridian channels with the same direction. When the acupuncturist dredges the meridian main stem to maintain meridian reaction, several needles may line up or bending needling in two meridians may connect in parallel or series. The maintaining of needles within meridian main stem allows the normal circulation of qi and blood. During which time, patients can feel a widespread benign swelling and distress from line to surface. This feeling is totally different from insertion, the feeling of traditional point-to-point acupuncture therapy. Such wide conduction from meridian line to surface achieves more favorable curative effects.

Compared with existing technologies, the invented filiform merge cluster needle applied in meridian bending needling therapy has the following characteristics. It is characterized by a combination structure composing of two or more needles, where needle handles are connected in parallel, and the needle bodies are separate and parallel to each other. First, the single filiform needle in prior arts had defects in direct insertion during bending needling manipulation with risks of breaking due to its thin body. However, bending needling applied with a thick and long needle may increase insertion pain and decrease the maintaining time due to a lower elasticity of the needle, which simultaneously put patients' security at risk and limit the patients' positions. On the contrary, the present invention is more secure during treatment. Secondly, the present invention adds thin sliding sleeves to the filiform merge cluster needle. Therefore, it is more applicable to uniformly bending needling of multiple needles, and operators can easily manipulate the insertion.

### DESCRIPTION OF DRAWINGS

The following articles shall elaborately illustrate this invention in detail based on the drawings.

FIG. 1 is a front schematic view of the structure of a filiform merge cluster needle applied in meridian bending needling, showing that there are two single needles connected in parallel by welding.

FIG. 2 is a left schematic view of the structure of a filiform merge cluster needle applied in meridian bending needling, showing that there are two single needles connected in parallel by welding.

FIG. 3 is a top schematic view of the structure of a filiform merge cluster needle applied in meridian bending needling, showing that there are two single needles connected in parallel by welding.

FIG. 4 is a bottom schematic view of the structure of a filiform merge cluster needle applied in meridian bending needling, showing that there are two single needles connected in parallel by welding.

FIG. 5 is a front schematic view of the structure of a filiform merge cluster needle applied in meridian bending needling, showing that there are three single needles connected in parallel by welding.

FIG. 6 is a left schematic view of the structure of a filiform merge cluster needle applied in meridian bending needling, showing that there are three single needles connected in parallel by welding.

FIG. 7 is a top schematic view of the structure of a filiform merge cluster needle applied in meridian bending needling, showing that there are three single needles connected in parallel by welding.

FIG. 8 is a bottom schematic view of the structure of a filiform merge cluster needle applied in meridian bending needling, showing that there are three single needles connected in parallel by welding.

FIG. 9 is a front schematic view of the structure of a filiform merge cluster needle applied in meridian bending needling, showing that there are four single needles connected in parallel by welding.

FIG. 10 is a left schematic view of the structure of a filiform merge cluster needle applied in meridian bending needling, showing that there are four single needles connected in parallel by welding.

FIG. 11 is a top schematic view of the structure of a filiform merge cluster needle applied in meridian bending needling, showing that there are four single needles connected in parallel by welding.

FIG. 12 is a bottom schematic view of the structure of a filiform merge cluster needle applied in meridian bending needling, showing that there are four single needles connected in parallel by welding.

FIG. 13 is a front schematic view of the structure of a filiform merge cluster needle applied in meridian bending needling, showing that there are four single needles connected as a character pattern of a “ [symbol] ” by welding.

FIG. 14 is a left schematic view of the structure of a filiform merge cluster needle applied in meridian bending needling, showing that there are four single needles connected as a character pattern of a “ [symbol] ” by welding.

FIG. 15 is a top schematic view of the structure of a filiform merge cluster needle applied in meridian bending needling, showing that there are four single needles connected as a character pattern of a “ [symbol] ” by welding.

FIG. 16 is a bottom schematic view of the structure of a filiform merge cluster needle applied in meridian bending needling, showing that there are four single needles connected as a character pattern of a “ [symbol] ” by welding.

FIG. 17 is a front schematic view of the structure of a filiform merge cluster needle applied in meridian bending needling, showing that there are three single needles connected as a character pattern of a “ [symbol] ” by welding.

FIG. 18 is a left schematic view of the structure of a filiform merge cluster needle applied in meridian bending needling, showing that there are three single needles connected as a character pattern of a “ [symbol] ” by welding.

FIG. 19 is a top schematic view of the structure of a filiform merge cluster needle applied in meridian bending needling, showing that there are three single needles connected as a character pattern of a “ [symbol] ” by welding.

FIG. 20 is a bottom schematic view of the structure of a filiform merge cluster needle applied in meridian bending needling, showing that there are three single needles connected as a character pattern of a “ [symbol] ” by welding.

FIG. 21 is a front schematic view of the structure of a filiform merge cluster needle applied in meridian bending needling, showing that there are two single needles connected in parallel by tape.

FIG. 22 is a left schematic view of the structure of a filiform merge cluster needle applied in meridian bending needling, showing that there are two single needles connected in parallel by tape.

FIG. 23 is a top schematic view of the structure of a filiform merge cluster needle applied in meridian bending needling, showing that there are two single needles connected in parallel by tape.

FIG. 24 is a bottom schematic view of the structure of a filiform merge cluster needle applied in meridian bending needling, showing that there are two single needles connected in parallel by tape.

FIG. 25 is a front schematic view of the structure of a filiform merge cluster needle applied in meridian bending needling, showing that there are two single needles connected by a fastener.

FIG. 26 is a left schematic view of the structure of a filiform merge cluster needle applied in meridian bending needling, showing that there are two single needles connected by a fastener.

FIG. 27 is a bottom schematic view of a fastener.

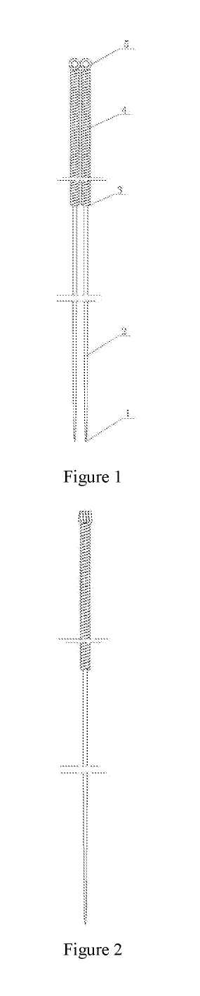

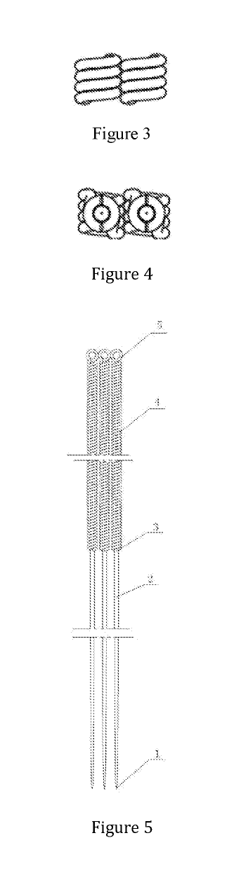

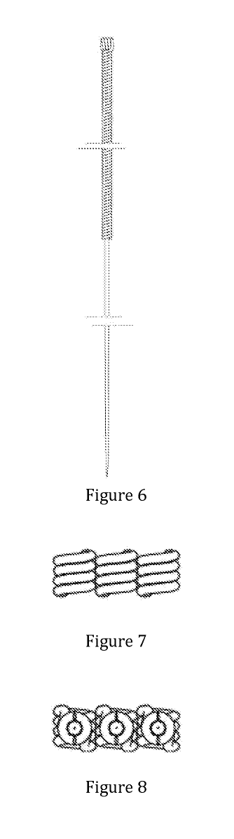

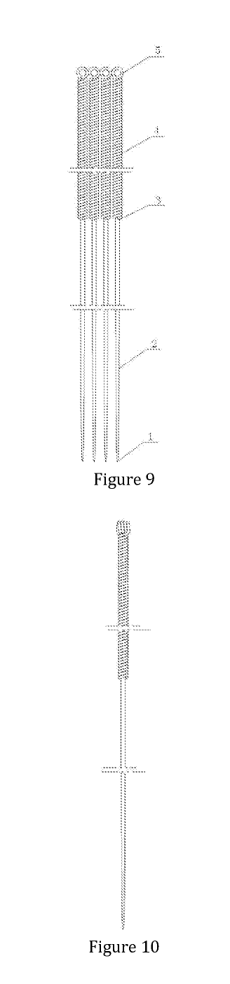

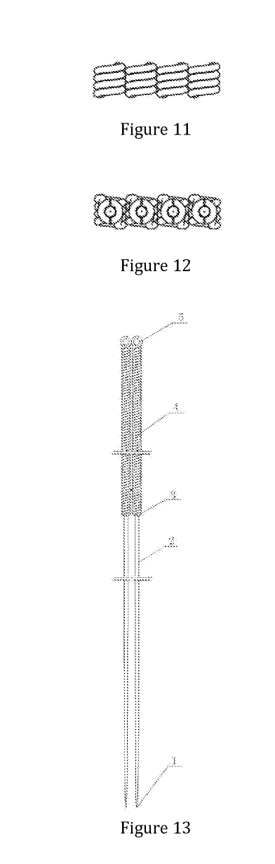

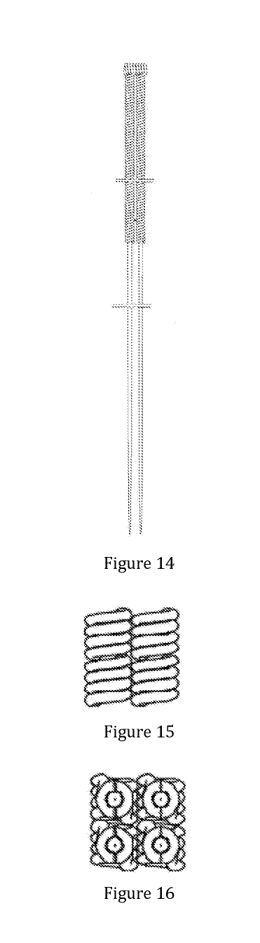

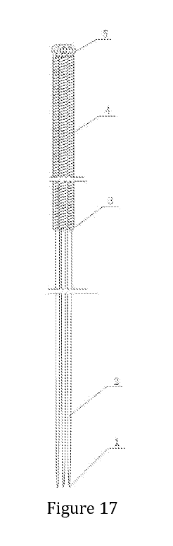

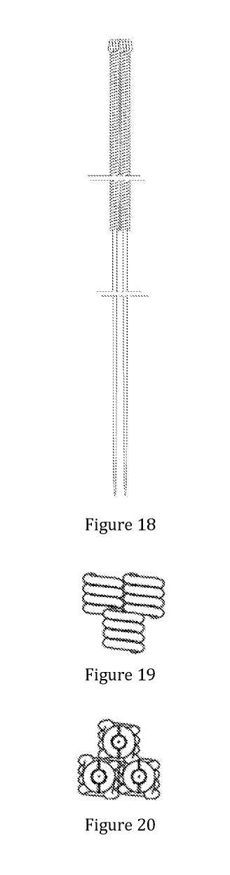

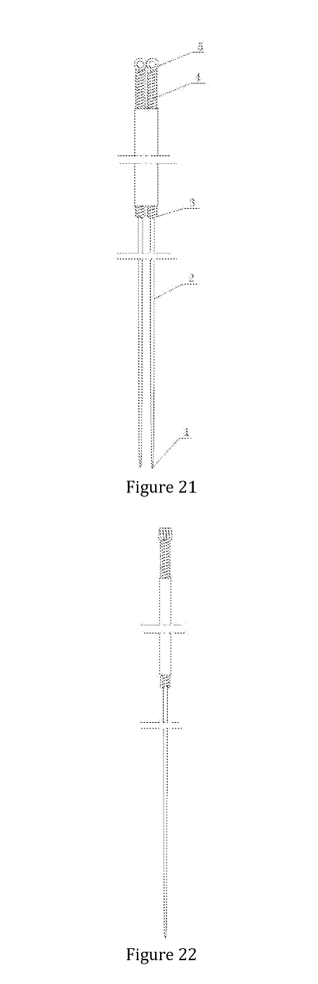

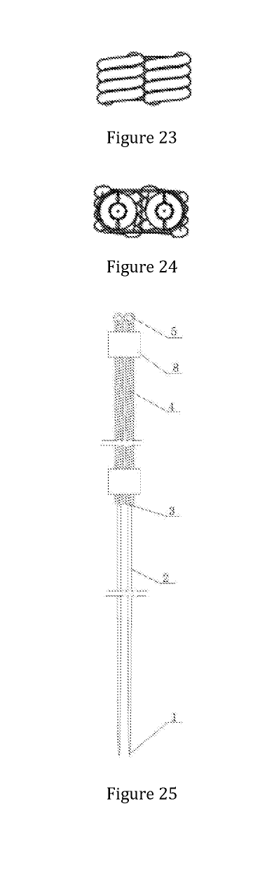

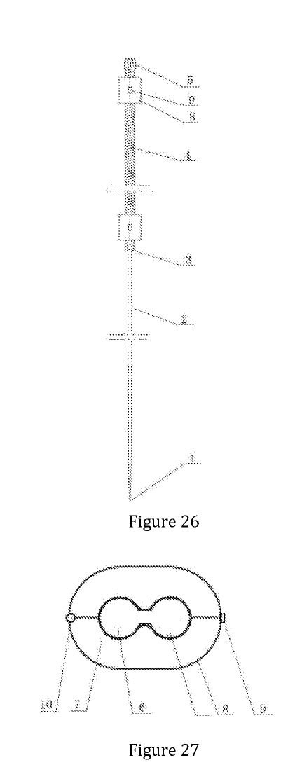

In the drawings, 1—needle tip, 2—needle body, 3—needle root, 4—needle handle, 5—needle end, 6—pinhole, 7—needle plate, 8—snap joint outside plate, 9—clip and 10—spindle.

### DETAILED DESCRIPTION OF THE EMBODIMENTS OF THE INVENTION

Based on the drawings, the following articles shall illustrate meridian bending needling therapy and filform merge cluster needle instrument in details.

The present invention, filiform merge cluster needle applied in meridian bending needling, is composed of two or more single needles connected in parallel. Each single needle comprises five parts including needle tip 1, needle body 2, needle root 3, needle handle 4, and needle end 5. Moreover, the fixation of single needles is achieved through binding, tapes, welding or fasteners.

One of the embodiments of the invention is when there are three single needles combined to form the filiform merge cluster needle, the three single needles connect in parallel with a cross-sectional view of a character pattern of a “ [symbol] ”. Another embodiment of the invention is when there are four needles, the four single needles are connected in parallel with a cross-sectional view of a character pattern of a “ [symbol] ” or a parallelogram.

The fasteners are composed of two fastener plates 8 with a spindle 10 and a clip 9 respectively on each end. The needle plate 7 is fixed within fastener plate 8 with a pinhole 6 in the middle, and at the same time, it possesses different tightness degrees. When the fasteners are closed, the pinhole 6 can effectively fix every single needle, which also denotes that the acupuncturists may draw out and move single needles with large force in order to alleviate pain. The needle plate 7 can be designed to be reusable or disposable, and therefore, it can be made of rubber or other similar material. In practice, two or more needles can be simultaneously manipulated. As for needle withdrawal, the acupuncturists can either draw out the whole needle cluster instrument at one time or just simply draw out each single needle after removing fasteners.

Needle handle 4 can be in a shape of a single cylinder, rectangle, or flat shape. Needle tip 1 and/or needle body 2 is set within a thin sliding sleeve, which is made by plastic or other material in a cylindrical form or rectangular form with a hollow center. Such design is convenient for manipulation.

Soldering or electric resistance welding is the optimal selection of welding fixation. During production procedures, two, three, or more single needles have to be fixed into a cluster needle instrument through two or more welding spots at handles.

The described meridian cluster needle can be divided into long cluster needles, medium-long cluster needles, medium cluster needles, and short cluster needles. The length of short cluster needles is 1-10 cm (0.5-3 cun); the length of medium cluster needles is 10-20 cm (3-6 cun); the length of medium-long cluster needles is 20-30 cm (6-9 cun); and the length of long cluster needles is over 30 cm (9 cun).

The needle instrument is mainly applied to the meridian bending needling therapy. Differing from the traditional vertical needling therapy, the meridian bending needling therapy requires the acupuncturists to obliquely insert a needle in 25° angle and subsequently, directly move along superficial muscular direction until the needle totally merges into patient skin. In other words, such kind of acupuncture therapy stimulates acupoints in series along meridian channel.

Every set of the needle instrument can only be applied on one patient. Moreover, the acupuncturists select muscular part of the body with meridian circulations, such as back, waist, abdomen, or proximal end of limb, during manipulation. For example, the acupuncturists can select Hsinshu to Dazhu/Shenshu to Pangguangshu segment along the bladder meridian (1.5 cun from spine) to treat Active Ankylosing Spondylitis. Acupuncturists may choose Weicang to Geguan segment along the bladder meridian (3 cun from a spine) to treat Chronic Gastritis. The selected meridian channel segment must be as simple and precise as possible. One insertion often treats four to twelve acupoints, and the treatment shall be conducted every one to four weeks.

The acupuncturists have to prepare skin sterilization appliances, tweezers and presently invented needle instruments, before performing treatments. First of all, make sure that the room environment and medical appliances are regularly sterilized, and room air is ventilated, so that the treatment environment is in favorable sanitation condition. Secondly, acupuncturists should wash hands with soap water and, subsequently, after the hands are dried, wipe hands with 75% ethanol cotton balls for further sterilization. Before needling manipulation, they must select meridian channel according to patients' conditions, inform patients of needling retaining time, and ask patients to choose appropriate acupuncture positions. More importantly, patients who are in severely weak or nervous state are often advised to select the clinostatism position during treatments, in case of fatigue or fainting. After needling positions are selected, manipulation acupoints shall be sterilized with 75% ethanol cotton balls, or sterilized with 2% iodine tincture before applying 75% ethanol cotton balls. The sterilization should be completed from up to down and from inside to outside. Manipulation acupoints' regions should be kept clear from pollutions after sterilization.

In consideration of the lengthiness of the presently invented needle instruments, acupuncturists should grasp the needles with both hands while practicing. To be specific, they shall wrap the bottom part of a needle body with a sterilized dry cotton ball with the thumb and the forefinger of the right hand. If the needle is equipped with a thin sliding sleeve, snap joints, or fixation clips, acupuncturists need to fix the thin sliding sleeve, snap joints, or fixation clips at a point 2-3 cm from the needle tip, which allows the needle tip to be exposed 1-2 cm. Acupuncturists grasp the needle handle and place the needle tip on patients' skin surface. If the needle instrument is connected by welding or taping, the acupuncturists have to insert the needle into the skin surface in an angle ranging from 10 to 30 degrees. Both hands cooperate with each other to insert the needle tip into the skin for 1 cm, and then, the acupuncturists should determine the insertion directions and angels according to the patients' body shape and weight. If the insertion direction derivates excessively from the meridian's orientation or the insertion angle is either too large or too small, the needle tip can be slightly drawn out and the insertion angle adjusted subcutaneously. After properly adjusted, the acupuncturist should forcibly push the needle handle to insert the needle in a direction parallel with skin surface with his or her left hand. In the meantime, the acupuncturist's right hand shall maintain the stability of the needle to prevent curve or breaking of the needle incurred by a patient's skin and/or muscular tissue resistance, or excessive hand force. If the adopted needle instrument is equipped with a thin sliding sleeve, snap joints, or fixation clips, the acupuncturist shall move the thin sliding sleeve, snap joints, or fixation clips to the needle handle's direction while inserting with right hand and keep the conformity of insertion direction of all needle parts. The manipulation ends when the whole needle body merges under the patient's skin surface.

If the needles are binded by tape, the tape can be removed during needling retaining period. Adopting the lifting inserting method and the twirling method to manipulate a single filform needle can strengthen stimulation and curative effects.

After the insertion, the patient shall be under observation for getting Qi, to be specific, whether or not the needle body triggered subcutaneous feelings such as swelling, anesthesia, hotness, coolness, itch, ache, convulsion, and/or formication. If not, the acupuncturist should wait for Qi's arrival through manipulation of the needles or reinsertions.

After the insertion and manipulation, the acupuncturists can fix the needle handles with sterilized medical tape to prevent needle sliding and advise patients not to move to prevent the needles' curving, sticking, or breaking.

Needle retaining period normally lasts for one to six hours, during which time the patients shall be under close observation. If fainting occurs, the patient can be attended to with immediate care.

Before withdrawal, the tape fixed on needle handles should be removed first. If the needle instrument is connected by welding, the acupuncturist should slightly press on manipulation acupoints with sterilized dry cotton ball held by the thumb and forefinger of his or her left hand. In the meantime, the needle should be extracted through the needle handle with his or her right hand. Retain the needle subcutaneously for a short period of time and remove the needle. The acupuncturist may respectively withdraw single filiform needles after removing tapes.

After withdrawing the needles, the acupuncturist should cautiously examine whether there is bleeding, discomfort, and delayed faint reaction and collate the number of the needles.

The presently invented needle instrument can be applied in meridian bending needling therapy with long needle retaining time. Because the needles are retained in the same direction with meridian and muscular direction, some manipulations will not affect a patient's ability to walk and perform light work. Therefore, needling retaining can last for several or even dozens of hours. Longitudinal manipulation on long meridian channels with long-time needle retaining can benignly enlarge curative effects, treatment coverage, and patients' compliance and effectively improve clinical symptoms, alleviate pains, and greatly save treatment time for patients.

The presently invented needle instrument modifies traditional vertical needling, oblique needling, and horizontal needling into bending needling with retaining method, which shall be applied with filiform needle cluster in longitudinal bending needling method along the meridian channel with long-time needle retaining time.

### The First Application Embodiment

Cervical Spondylosis

1. Diagnostic Standards

Diagnostic classification standards of nerve-root type cervical spondylosis: Referring to the summary of the second session of cervical spondylosis forum in 1992.
(1) Radical distribution symptoms (numbness and pain) and signs;
(2) Spurling test and/or positive eaton test;
(3) Iconography representation is basically consistent with clinical manifestation;
(4) Excluding pain caused by cervical vertebra lesion (thoracic outlet syndrome, radiohumeral bursitis, carpal tunnel syndrome, cubital tunnel syndrome, scapulohumeral periarthritis and biceps tendinitis).

2. Selection Standards of Test Case

2.1 Incorporated Case Standards

All patients conforming to diagnostic standards can be classified into the observation case list.

2.2 Excluded Case Standards
(1) Patients with severe primary diseases such as angiocarpy disease, hepatopathy, mephropathy, or hemopoietic system disease, or patients with mental illnesses;
(2) Patients with cervical cancer and tuberculosis;
(3) Patients during gestation period or lactation period;
(4) Patients who are extremely afraid of needling;
(5) Patients with allergic constitution and allergic to multiple medicines.

2.3. Eliminated Case Standards

(1) Detachment: Patients who suspend treatment and do not obtain follow-up visit before treatments accomplished for multiple reasons;

(2) Contamination: Patients who have taken painkiller or other relevant Traditional Chinese or Western medicine during observation period;

(3) Noncompliance: Patients who do not get timely subsequent treatment and medicine; Patients who have uncertain curative medicine effects or incomplete medical documents; Patients who voluntarily quit the test;

(4) Interference: Patients who get other diseases and accept corresponding treatments; Patients who have accepted other treatments, which may influence effect observers.

3. Division: The 60 cases are all from rheumatology department and senior specialist department of the affiliated hospital of Shandong Traditional Chinese Medicine University.

There are 30 cases in the experimental group, among which male cases are 8 and female cases are 22 with a percentage of 0.36:1 between male and female. The youngest patient is 30 years old and the oldest patient is 65 years old. Average disease-incidence-age range is 43.70±9.54. The shortest treatment session lasts for half a month and the longest lasts for 20 years. Average treatment time is 59.48±65.09 months. There are 30 cases in the control group: 10 male cases and 20 female cases with a percentage of 0.5:1 between them. The youngest patient is 35 years old and the oldest patient is 66 years old. Average disease-incidence-age range is 49.30±9.14. The shortest treatment session lasts for 8 months and the longest lasts for 12 years. Average treatment time is 58.90±48.69 months. There are no obvious differentiations between two groups of patients in terms of gender, disease-incidence-age, treatment session (P >0.05) (see Table 1-3), and disease condition (P >0.05) (see Table 5-6) before treatment. Therefore, the two groups are comparable.

The experimental group adopts the presently invented meridian therapy while the control group utilizes oral liquid solution of JingYu decoction.

(1) Meridian Therapy

The acupuncturists select bilateral Fengmen acupoint to Tianzhu meridian channel segment (the second processus spinosus of vertebra thoracic to 1.5 cun away from the middle of the posterior of hairline). The patients sit against the acupuncturists and expose acupuncture positions, and the acupuncturists perform skin sterilization from up to down. The needle handles are fixed as a letter pattern of a “ [symbol] ” by welding, and the body of each needle was made with a length of 75 mm and a diameter of 0.33 mm. After inserting the needles in a 25° angle with a depth of 1 cm into a patient's skin, the patient can get a two-minute break while needles retained in his or her skin. Subsequently, the long needle will be inserted along the subcutaneous shallow muscular layer until the needle is fully emerged. Four needle clusters are retained in a patient's body for one to two hours. The treatment shall repeat once a week. Four weeks constitute one treatment course.

(2) Prescription and Dosage of Oral Liquid Solution of JingYu Decoction.

The prescription is composed of 30 g pueraria, 10 g cassia twig, 20 g red peony, 10 g safflower, 20 g notopterygium incisum, 10 g peach kernel, 20 g sergeant gloryvine, 15 g radix clematidis, 12 g anemonis raddeanae, and 6 g licorice.

Decocting and treatment method: Immerse the abovementioned medicinal materials for one to two hours. Decoct twice and then extract 400 ml decoction. Drink 200 ml decoction in a warm condition twice a day half an hour after meals. Keep taking the decoctions every day and stop taking for one day after every six days.

4. Curative Effects Observation

4.1 Treatment Integration and Improvement Index of Cervical Spondylosis

(1) Improvements based on symptoms and comprehensive asymptomatic assessment before and after treatment are described as follows. Clinical curative effect mark sheets shall be established to record patients' pains in neck, shoulder, back, and upper limb and/or numbness, movement aches, headaches, dizziness, tenderness, and coping and/or patients' symptoms after spurling test, eaton test, and hyperextension test as well as patients' general symptoms variation before and after treatment. The data shall be converted into corresponding scores.

(2) Grading Pains According to VAS Analogue Scale

5. Results

The overall effective rate of the experimental group is 100%, among which positive case are 17 (56.67%), weak positive cases are 9 (30.00%), strong positive cases are 4 (13.33%) and negative cases are (0.00%) (see Table 4). By comparison, the overall effective rate of the control group is 73.33%, among which positive cases are 3 (10%), weak positive cases are 6 (20.00%), strong positive cases are 13 (43.33%) and negative cases are 8 (26.67%).

### The Second Application Embodiment

Ankylosing Spondylitis

1. Diagnostic Standards

The diagnostic standards of Ankylosing Spondylosis are “New York Standard revised by American Rheumatism Association in 1984.” The diagnostic standards of active Ankylosing Spondylosis refer to “The New Clinical Research Guiding Principles of Traditional Chinese Medicine The Clinical Research Guiding Principles of Ankylosing Spondylosis.”

2. Case Source

All cases are hospitalized patients or outpatients of ankylosing spondylitis from the rheumatism department of the affiliated hospital of Shandong Traditional Chinese Medicine University. According to case incorporation standards and exclusion standards, this clinical trial altogether collects 70 patient cases as the observation cases, among which hospitalized patients cases are 42 and outpatients cases are 28. Subsequently, all cases are randomly divided into a treatment group and a control group. There are 35 cases in each group.

There are no obvious differentiations (P >0.05) between the two groups in terms of patients' gender, age, disease course, main symptoms, minor symptoms, tong nature, tong coating, pulse condition, overall functions, primary signs, ESR, CRP and IgA.

The treatment group adopts meridian therapy while the control group gives one dose of Jibi decoction to every patient every day.

3. Treatment Method

3.1 Meridian Therapy

The acupuncturists shall select bilateral sanchiaoshu to Hsiaochangshu meridian channel segment (the first lumbar vertebra to 1.5 cun away from the first processus spinosus of vertebra sacrale) and bilateral Huangmen and Baohuang meridian (the first lumbar spinous down to 3 cun away from the second posterior sacral foramina). The patients are required to sit against the acupuncturists and expose acupuncture positions, and the acupuncturists perform skin sterilization from up to down. The needle handles are fixed as a letter pattern of a “ [symbol] ” by welding, and the body of each needle was made with a length of 75 mm and a diameter of 0.33 mm. After inserting the needles in a 25° angle with a depth of 1 cm, the patient can get a two-minute break while needles retain in his or her body. Subsequently, the long needle will be directly inserted along subcutaneous shallow muscular layer until the needle is fully emerged. Eight clusters of needles are retained in a patient's body for one to two hours. The treatment shall repeat once a week. Four weeks constitute one treatment course, and patients are expected to get three treatment courses according to their curative effects.

3.2 Prescription and Dosage of Oral Liquid Solution of Jibi Decoction

The prescription is composed of 30 g honeysuckle, 20 g sergeant gloryvine, 20 g rhizoma smilacis glabrae, 20 g radix angelicae pubescentis, 20 g radix cyathulae, 20 g radix dipsaci, 12 g tu-chung, 20 g radix paeonia rubra, 20 g radix paeoniae alba, 6 g hirudo, 10 g rhizome smilacis glabrase, 10 g ground beetle, 15 g radix cyathulae, and 12 g piper cubera. Decoct the abovementioned medical materials twice and then extract the medical soup. Drink the decoction in a warm condition twice a day half an hour after the meal. One treatment course lasts for three months.

4. Comprehensive Curative Effects Criteria

Based on “The New Clinical Research Guiding Principles of Traditional Chinese Medicine The Clinical Research Guiding Principles of Ankylosing Spondylosis,” curative effects assessment standards shall be described as follows: 1. Short-term control: After a three-month treatment, main symptoms and minor symptoms shall basically disappear, main signs and main laboratory indexes (ESR, CRP and IgA) return to normal, BAS-G BASDAI, and BASFI values decrease 95% or more, and there is no sclerotin variation improvements revealed by bilateral sacroiliac joint X-ray frontal film. Continuous treatment can relieve disease symptoms. 2. Positive effects: Within a three-month treatment, symptoms aggregated scores decrease two thirds or even more than previous ones, main signs and main laboratory index values increase by two thirds or more, and BAS-G BASDAI, and BASFI values decrease by 75% or more. Continuous treatment maintains patients' conditions. 3. Weak positive effects: Within a three-month treatment, symptoms aggregated scores decrease by one third or more, but less than two thirds. Main signs and main test index values increase by one third or more, but less than two thirds. BAS-G BASDAI, and BASFI values decrease by 50% or more. 4. Negative effects: Within a three-month treatment, the main and minor symptoms are improved but still unstable, and the symptoms aggregated scores decrease by one third. Main signs and main test index values increase by less than one third. BAS-G BASDAI, and BASFI values decrease by less than 50%.

5. Results

As for the overall effective rate (weak positive rate plus positive rate), the treatment group is 100% and the control group is 83.33%. While in terms of positive rate, the treatment group is 62.50% and the control group is 22.22%.

### The Third Application Embodiment

Lumbago

Name: Mr. Hou

Gender: Male

Age: 32

Job: Bank clerk

Address: No. 150, Luoyuan Avenue, Lixia District, Jinan

Phone number: 185****6389.

The patient first sought treatment on May 6, 2014. The patient had continuous swelling pains and stiffness of a fixed part on his waist, especially after sitting for a long time. This condition started without an obvious triggering event half a year ago. Starting a week ago, the pain got worse, and the patient found difficulty in bending over to pick up things or turning back. The application of lumbago plaster did not relieve pain. Therefore, the patient sought to receive treatment in out-patient department.

Physical examination: The patient had obvious pressing pains between the forth and fifth spinal columns and bilateral sides between the second spinal column and the fifth spinal column. The trunk extension test and straight-leg raising test were both negative. The degree of both lower limb myodynamia was five. There were no abnormal conditions in sella turcica region and lower limb skin. Bilateral tendo calcaneus and patellar tendon reflex worked well. There was no abnormity in pathological signs. The lumbar iconography examination did not reveal obvious abnormity in lumbar vertebra, but its physiological curvature slightly turned straight.

Diagnosis: Chronic Lumbar Muscle Strain

Treatment: The acupuncturists shall select bilateral Ganshu meridian to Guanyuanshu meridian channel segment (the ninth thoracic vertebra to 1.5 cun away from the fifth lumbar vertebra processus spinosus) and bilateral Hunmen to Baohuang meridian channel segment (the ninth thoracic vertebra processus spinosus to 3 cun away from the second posterior sacral foramina). The patient sat against the acupuncturist and exposed acupuncture positions, and the acupuncturist performed skin sterilization from up to down. The needle handles were fixed as a letter pattern of a “ [symbol] ” by welding, and the body of each needle was made with a length of 75 mm and a diameter of 0.33 mm. After inserting the needles in a 25° angle with a depth of 1 cm, the patient could get a two-minute break while the needles retained in his body. Subsequently, the needles would be directly inserted along subcutaneous shallow muscular layer until the needles were fully emerged. Six clusters of needles were retained in his body for one to two hours. The acupuncturist advised the patient not to participate any heavy labor work and receive a return visit one week later.

The second visit was on May 15, 2014. The patient informed that swelling pain in back waist were obviously alleviated, and he could bend over to pick up things without stiffness.

Physical examination showed that the patient had slight pressing pains between the forth and fifth spinal columns and bilateral sides between the second spinal column and the fifth spinal column. The treatment therapy was the same with the previous one, and the needling retaining time lasted for two hours.

A phone follow-up visit was conducted on Dec. 9, 2014. There were no lumbago symptoms or any lumbar discomfort. The patient could freely turn back and bend over.

### The Fourth Application Embodiment

Scapulohumeral periarthritis

Name: Ms. Wang

Gender: Female

Age: 57

Job: Housewife

Address: No. 381, Dongfengdong Avenue, Weifang

Home number: 0536-68***707

First visit was on Feb. 28, 2014. The patient suffered from recurrent attacks of right shoulder pains accompanied with sensations of chill for two years and the pain exacerbated a week before the visitation. The patient always did housework, and she began to suffer continuous dull pain in her right shoulder joint after lifting a heavy object two years ago. She also had sensations of wind and chill and experienced difficulties in combing hair and dressing up. The symptoms were worse during nights than days. The application of pain-killing ointment accompanied with hot compress could alleviate the pains. In recent two years, the shoulder pain occurred repeatedly and the pain was progressively aggravated. One week ago, her shoulder joint pain was suddenly aggravated due to an exposure in rain, and the pain spread to her neck and right upper limb. Application of hot compress and painkillers (medicine's name was unknown) did not relieve the pain.

Physical examination: There was obvious pressing pain in the tendon groove of long head of biceps brachii and supraspinatus attachment points. Gestures such as shoulder joint abduction, uplift, internal rotation and external rotation were limited.

X-ray film of shoulder joint shows that there were low density and unevenly spread calcification spots in the joint capsule, bursa synovialis, supraspinatus, and tendon of long head of biceps brachii.

Diagnosis: Scapulohumeral Periarthritis.

Treatment: The acupuncturist selected right Tushu to Jianzhongshu meridian channel segment (1.5 cun away from the sixth thoracic vertebra processus spinosus to 2 cun away from the seventh cervical vertebra processus spinosus), Yixi to Jianwaishu meridian channel segment (the sixth thoracic vertebra processus spinosus to 3 cun away from the first thoracic vertebra processus spinosus), and Jianliao to Qinglengyuan meridian channel segment (from the pit of acromion posterior aspect during shoulder joint abduction to 2 cun up from the elbow point during right arm elbow bent). The patient sat against the acupuncturist and exposed her right shoulder and back, and the acupuncturist performed skin sterilization from up to down. The needle handles were fixed as a letter pattern of a “ [symbol] ” by welding, and each of the needle body was made with a length of 75 mm and a diameter of 0.33 mm. After inserting the needle cluster in a 25° angle with a depth of 1 cm into a patient's skin, the patient can get a two-minute break while needles retained in her skin. Subsequently, the long needle will be inserted along the subcutaneous shallow muscular layer until the needle is fully emerged. Four needles clusters are retained in a patient's body for two hours. The treatment shall repeat once a week. The acupuncturist advised the patient not to move her right upper limb fiercely and revisit one week later. After two treatments (once a week with two to three hours needle retaining time), the patient's symptoms of sensation of wind and chill disappeared, and she could normally lift her shoulder joint and perform shoulder joint abduction gestures. The acupuncturist told the patient not to fiercely move her right upper limb as well as lift heavy objects. Until a follow-up phone visit on Dec. 9, 2014, the disease did not recur.

### The Fifth Application Embodiment

Headache

Name: Ms. Shang

Gender: Female

Age: 54

Job: Senior executive of a bank

Address: No. 38, Shungeng Road, Jinan City

Phone number: 186****6618

First visit was on Dec. 12, 2012. The patient suffered from repeated attacks of headaches for more than 10 years and the pain was suddenly aggravated for one day. The patient usually suffered from headaches caused by agitation or insufficient sleep. The headaches were swelling pain on unfixed spots ranging from occipitalia, forehead and bitemporal. The patient felt sickness and vomited when experiencing severe pain. The pain was aggravated after performed physical or mental work or moved head and changed positions. She also had difficulty falling asleep and suffered excessive dreaming and slumber. Sometimes, the symptoms could be alleviated after taking Zhengtian pills and Yangxue Qingnao granule. One day ago, the patient suffered headaches, sickness, and insomnia after performed a heavy load of works, and the symptoms were not relieved after taking over-the-counter medicine. The patient did not have high blood pressure, diabetes, or coronary heart diseases.

Physical examination showed that vital signs were stable, and neurologic examination showed that physiological reflections existed. There were no obvious pathological reflections. And there were no abnormal conditions in electrocardiogram, electroencephalogram, or brain CT examination.

Diagnosis: Cluster Headache Syndrome.

Treatment: The acupuncturist selected bilateral Fengmen to Tienshu meridian channel segment (the second thoracic vertebra processus spinosus to 1.5 cun away from the middle of the posterior hairline). The patient sat against the acupuncturist and exposed treatment positions, and the acupuncturist performed skin sterilization from up to down. The needle handles are fixed as a letter pattern of a “ [symbol] ” by welding, and each the needle body was made with a length of 75 mm and a diameter of 0.33 mm. After inserting the needle cluster in a 25° angle with a depth of 1 cm into a patient's skin, the patient could get a two-minute break while needles retained in his or her skin. Subsequently, the long needle will be inserted along the subcutaneous shallow muscular layer until the needle is fully emerged. Four needle clusters were retained in the patient's body for one to two hours. Once inserted, the patient felt the alleviation of headaches, and until needles' withdrawal the headaches and discomforts became obscure. The acupuncturist advised the patient to rest regularly and revisit one week later. After two treatments (once a week with one to two hours needle retaining time), the patient's symptoms of headache, sickness, and insomnia disappeared and, therefore, stopped the treatments. Until a follow-up phone visit on Dec. 9, 2014, the disease did not recur.

### The Sixth Application Embodiment

Chronic rhinitis

Name: John Doe

Gender: Male

Age: 32

Job: Staff member

Address: No. 19, Keyuan Road, Jinan City.

Phone number: 186****9645

First visit was on Dec. 12, 2012. The patient suffered from intermittent nasal obstruction and running nose for one year, and the symptoms were suddenly aggravated for one month. During a business trip, the patient caught a cold and did not get timely and systematic treatment. As a result, the symptoms of nasal obstruction and running nose stopped after one moth. Thereafter, whenever the patient caught a cold, he ran clear nasal discharge, and the symptoms were aggravated at night. One month ago, the patient caught a cold again. At first, the patient ran large amount of translucent and mucinous nasal discharge, which could be easily removed. Later, the amount of nasal discharge decreased but symptoms such as rhinobyon, hyposmia, headache, dizziness, insomnia, and spirit atrophy occurred.

Physical examination: The patient suffered hearing loss and nasal mucosa swelling with smooth surface. After slightly pressing the obviously soft and elastic turbinate, the hollow would immediately recover after removal.

Diagnosis: Chronic Rhinitis.

Treatment: The acupuncturist selected bilateral Fengmen to Tianzhu meridian channel segment (the second thoracic vertebra processus spinosus to 1.5 cun away from the middle of posterior hairline). The patient sat against the acupuncturist and exposed treatment positions, and the acupuncturist performed skin sterilization from up to down. The needle handles are fixed as a letter pattern of a “ [symbol] ” by welding, and each needle body was made with a length of 75 mm and a diameter of 0.33 mm. After inserting the needle cluster in a 25° angle with a depth of 1 cm into the patient's skin, the patient can get a two-minute break while needles retained in his skin. Subsequently, the long needles will be inserted along the subcutaneous shallow muscular layer until the needles are fully emerged. Four needle clusters were retained in the patient's body for one to two hours. Once insertion started, the patient felt the alleviation of rhinobyon and headache. The acupuncturist advised the patient to rest regularly and revisit one week later. After six treatments (once a week with one to two hours needle retaining time), patient's symptoms of rhinobyon and nasal discharge disappeared, and the patient did not catch a cold.

### The Seventh Application Embodiment

Recurrent Oral Ulceration

Name: Jane Doe

Gender: Female

Age: 28

First visit was on Jul. 25, 2012. The patient suffered from intermittent recurrent oral ulceration with pain for two years. Two years ago, the patient suffered fierce burning pain of oral mucosa with clear superficial aphtha without obvious cause. Generally, the aphtha would automatically recover within 10 to 20 days. The aphtha continuously grew and recovered, and there would be more than 10 aphtha regions at one time, at most. There were no abnormal indicators in antinuclear antibodies examination, anti-endothelial cell antibody examination, erythrocyte sedimentation rate examination, and C reactive protein examination.

Diagnosis: Recurrent Oral Ulceration

Treatment: The acupuncturist selected bilateral Fengmne to Tianzhu meridian channel segment (the second thoracic vertebra processus spinosus to 1.5 cun away from the middle of posterior hairline). The patient sat against the acupuncturist and exposed right shoulder and back, and the acupuncturist performed skin sterilization from up to down. The needle handles are fixed as a letter pattern of a “ [symbol] ” by welding, and each needle body was made with a length of 75 mm and a diameter of 0.33 mm. After inserting the needle cluster in a 25° angle with a depth of 1 cm into a patient's skin, the patient can get a two-minute break while needles retained in her skin. Subsequently, the long needles will be inserted along the subcutaneous shallow muscular layer until the needles are fully emerged. Four needle clusters are retained in the patient's body for one to two hours. Once insertion started, the patient felt the alleviation of aphtha pains. The acupuncturist advised the patient to avoid any irritating foods and revisit one week later.

After seven treatments (once a week with one to two hours needle retaining time), the patient's symptoms of aphtha gradually recovered. There were still new aphtha growing in the third week, and after the fifth week, the disease was totally cured.

### The Eighth Application Embodiment

Gout

Name: John Doe

Gender: Male

Age: 45

Job: government officer

First visit was on Nov. 2, 2014. The patient suffered from repeated stabbing pain in the first metatarsophalangeal joint of his left foot for more than three years and the pain was aggravated one day ago. The patient usually ate seafood and meat. Three years ago, the patient suddenly experienced severe pain in the first metatarsophalangeal joint of left foot with partial swelling and hotness. He was diagnosed with gout by Shandong Provincial Hospital and was prescribed colchicine and non-steroid anti-inflammatory drugs. After the pain alleviated, the patient took benzbromarone in order to control disease conditions. The pain repeatedly occurred for three times due to patient's improper diet control. At the present time, the patient suffered great pain in the first metatarsophalangeal joint and found difficulty in walking and falling asleep. His pain was not relieved after taking colchicine and non-steroid anti-inflammatory drugs. The patient had twenty years of smoking history and eighteen years of drinking history with an average of 1 L of beer every day. The erythrocyte sedimentation rate was 21 mm/h and the blood uric acid was 637 umol/L.

Diagnosis: Acute Gout Attacks.

Treatment: The acupuncturist selected left Heyang-Chengshan, Yanglingquan-Xuanzhong, Diji-Sanyinjiao, Zusanli-Xiajuxu, and Yanglingquan-Guangming meridian channel segments. The patient sat against the acupuncturist and raised his left lower limb vertically to expose treatment positions, and the acupuncturist performed skin sterilization from up to down. The needle handles are fixed as a letter pattern of a “ [symbol] ” by welding, and each needle body was made with a length of 75 mm and a diameter of 0.33 mm. After inserting the needle cluster in a 25° angle with a depth of 1 cm into the patient's skin, the patient can get a two-minute break while needles retained in skin. Subsequently, the long needles will be inserted along the subcutaneous shallow muscular layer until the needles are fully emerged. Five needle clusters are retained in the patient's body for one to two hours. Once insertion started, the patient felt alleviation of the pain. After needle withdrawal, the patient found the pain was almost completely relieved and walked home on his own. The acupuncturist advised the patient to rest regularly, and keep a low-fat and low-purine diet. The disease did not reoccur until a phone follow-up visit on Dec. 9, 2014.

What is claimed is:

1. A method for treating patients with meridian bending needling therapy, comprising:
1) preparation steps including:
preparing skin sterilization articles, tweezers and needling devices: making sure that room environment and medical articles are regularly sterilized; cleaning hands with suds and/or 75% ethanol; selecting meridian channels according to patients' conditions, and informing patients of needling retaining time as well as appropriate acupuncture position; advising patients who are in severely weak or nervous state to select clinostatism position during treatments; sterilizing selected acupoints with 75% ethanol or 2% iodine tincture; and keeping said acupoints clear from pollutions;
2) manipulation steps including:
pinching said needling devices with both hands,; wrapping latter part of a needle with said sterilization articles with right hand; placing a needle tip on patients' skin surface; inserting said device in an insertion direction and an insertion angle determined by patients' body shape and weight; drawing out said needle tip and adjusting subcutaneously when insertion direction derivate excessively from meridian channels' orientations or insertion angle is either oversized or undersized; grasping needle handle with a left hand and inserting with force in a direction paralleling with patient's skin surface; maintaining stability of right hand in order to prevent curve or breaking of device; inserting said device until full immergence of needle body into patients' skin surface;
3) needle retaining and observation steps including:
fixing needle handle to patients skin surface; advising patients not to move; observing patients for acuesthesia phenomenon, such as subcutaneous swelling, anesthesia, hotness, coolness, itch, ache, convulsion, and formication; retaining device in patient's body for one to six hours; closely observing patients to guarantee a timely treatment if patients faint;
4) device withdrawal steps:
pressing acupoints with sterilized articles; slowly withdrawing device with right hand; examining needle numbers and observing patients for hemorrhage, discomfort, and faint delayed reaction.

2. A filiform merge cluster needle device, applied in method of claim 1, comprising two or more single needles fixed together through binding, tape, welding, or snap joint; each one of said single needle includes a needle tip, needle body, needle root, needle handle, and needle end connected respectively.

3. The device of claim 2, wherein if said device comprising two single needles, single needles connect in parallel.

4. The device of claim 2, wherein if said device comprising three said single needles, said single needles are connected in parallel on coplane.

5. The device of claim 2, wherein if said device comprising four single needles, said single needles are connected in parallel on coplane.

6. The device of claim 2, wherein said device comprising three single needles, said single needles are connected in parallel with a cross-sectional view of a character pattern of a “ [symbol] ”.

7. The device of claim 2, wherein said device comprising four single needles, said single needles are connected in parallel with a cross-sectional view of a character pattern of a “ [symbol] ”.

8. The device of claim 2, wherein said snap joints including two snap joint outside plates, a spindle connects to one end of one of said outside plates, and a clip connects to one end of the other said outside plate; a needle plate located within said snap joint outside plates;
pinholes located in the middle of said needle plate.

9. The device of claim 2, wherein said needle handle is in a form of a cylinder, rectangle or flat shape.

10. The device of claim 2, wherein said needle tip and/or needle body is equipped with a thin sliding sleeve.
